(19) United States
(12) Patent Application Publication
(10) Pub. No.: US 2010/0145874 A1
(43) Pub. Date: Jun. 10, 2010

(54) METHOD AND APPARATUS FOR MULTI-LEG TRADING

(75) Inventor: Braden S. Janowski, Tulsa, OK (US)

Correspondence Address: TRADEHELM, INC., 5727 S. LEWIS AVE, STE. 500, TULSA, OK, 74105, US

(73) Assignee: TradeHelm, Inc., Tulsa, OK (US)

(21) Appl. No.: 12/331,081

(22) Filed: Dec. 9, 2008

(51) Int. Cl. G06Q 40/00

(52) U.S. Cl. 705/36 R

(57) ABSTRACT

Trading of multi-leg strategies is facilitated by a computerized system and method that enables a trader to efficiently define and trade a multi-leg instrument while minimizing leg risk. The multi-leg instrument may be defined to include one or more execution triggers, such as contingencies that delay submittal of trade orders for contingent leg instruments until the contingencies are met, and dynamic re-pricing that re-prices the leg instruments when a market update is received. The precise method of execution will vary according to how the multi-leg instrument is configured. Trade orders for contingent legs (including contingent legs configured for dynamic re-pricing) are held in abeyance until all contingencies have been met. Trade orders for non-contingent dynamically re-priced legs are submitted immediately at a leg price and leg quantity. Trade orders for non-contingent, non-dynamically re-priced legs are submitted to an exchange when the market crosses the multi-leg instrument (i.e., when current market data reflects that all legs of the multi-leg instrument is available for acquisition at the leg price and leg quantity). For any leg which is not fully filled after an initial trade order for that leg is submitted, a subsequent trade order will be sent for the remaining leg quantity at a leg price that is determined based on the fill price of all fully and partially filled legs.

### FIELD OF THE INVENTION

The present invention is generally directed to trading of financial instruments. More particularly, the invention is directed to a method and apparatus for facilitating the creation and trading of synthetic multi-leg instruments.

### BACKGROUND OF THE INVENTION

Financial instruments can be traded in many ways in today's electronic trading environment. To trade a single instrument, a trader will typically watch live market data related to the instrument and monitor certain parameters (such as the trading frequency of the instrument, it's price movement, market depth, etc.) to determine when to place trades for the instrument. Because the trader is able to easily monitor current market conditions as they relate to only one instrument, trades for the instrument can be placed by the trader with a relatively high level of confidence that the trade will be executed at a desired price and quantity.

That confidence level decreases, however, as the trader engages in more complex trading strategies. For example, in a trading strategy that involves trading multiple instruments in combination (i.e., a multi-leg strategy), the ability of the trader to monitor current market conditions for each leg of the strategy becomes strained. The trader may make execution of one or more legs continent on execution of one or more other legs, which adds more complexity. Complexity is further increased when one or more legs of the strategy involve resting limit orders and the trader wishes to re-price the resting legs based on changes in market conditions. And if the multi-leg strategy is fractionally filled (as often occurs), the trader is faced with a difficult situation in determining how best to reduce leg risk and implement the remainder of the strategy, and at what price. Fractional fills can place the trader in a position of greatly increased risk since profitability of the multi-leg strategy is usually highly dependent on getting all legs fully filled at the strategized prices. Accordingly, multi-leg strategies can carry significantly greater risk than single-leg strategies, and that risk increases when one or more of the legs are in less liquid markets.

What is needed, therefore, is a method and apparatus that facilitates a trader's implementation of multi-leg strategies.

### SUMMARY OF THE INVENTION

The present invention can be summarized as a method for trading a multi-leg financial instrument. The method includes defining a multi-leg instrument having two or more legs with each leg represents a financial instrument (leg instrument), a price (leg price) for the financial instrument, and a quantity (leg quantity) of the financial instrument that comprises one unit of the multi-leg instrument. The multi-leg instrument is a synthetic instrument with a synthetic price represented by a multi-leg definition that equates the synthetic price for one unit of the multi-leg instrument to an aggregation of items including the leg price and leg quantity of each leg. A leg submittal trigger is determined for each leg representing one or more requirements that must be met before a trade order for the leg instrument can be submitted to an exchange. Current market activity is monitored for each leg instrument to determine a current status for leg price availability and leg quantity availability, and a first trade order is submitted to an exchange for each leg at the leg price and leg quantity when the leg submittal trigger is met. For each leg in which the desired leg quantity is not fully filled (remainder leg) after any quantity for any leg has been filled, an updated leg price is calculated based on the fill price(s) for all filled and partially filled legs. A subsequent trade order is sent to an exchange for each remainder leg at the updated leg price and for the amount of the leg quantity that remains unfilled (remainder quantity) when the leg submittal trigger for the remainder leg is met. Updated leg prices are calculated and subsequent trade orders are submitted in a repeating cycle until the multi-leg order is fully filled.

The leg submittal trigger can take a variety of forms. For example, the leg submittal trigger for all legs (including remainder legs) may include a wait requirement that delays submittal of a trade order until current market activity shows that each leg (and remainder leg) is available at the leg price and leg quantity (or remainder quantity for remainder legs). Each leg/remainder leg may be considered available at the desired leg price and quantity/remainder quantity when current market activity shows that the applicable leg quantity can be fully filled at a current market price that is equal to or more favorable than the leg price/updated leg price.

In another example, the leg submittal trigger for one or more legs may include a no wait requirement that immediately submits the first trade order to an exchange.

In a further example, the leg submittal trigger for one or more legs may include a contingency requirement that delays submittal of the first trade order to an exchange until all contingency requirements have been met. An example of a contingency requirement is to delay submittal of the first trade order until all other non-contingent leg have been fully filled.

The method may further include discretely submitting a trade order to an exchange prior to when each leg of the multi-leg instrument becomes available, and then updating the leg price for all remainder legs based on the fill price of the discretely submitted trade order and all other fully and partially filled trade orders.

In a further aspect of the method, at least one leg of the multi-leg instrument includes a dynamically adjustable leg price that changes when current market activity reflects a change in market price of an instrument used for pricing a leg of the multi-leg instrument.

The synthetic price for the multi-leg instrument may be specified by a trader, whereby the leg price for each leg instrument is determined by solving the multi-leg definition.

The present invention also provides an apparatus for allowing a trader to submit trade orders for a multi-leg financial instrument from an electronic processing device to one or more electronic exchanges. The apparatus includes a graphical user display device, a user input device (such as mouse and/or keyboard), a communication network for electronically communicating with one or more electronic exchanges, and a programmable processing device in communication with the display device, user input device, and communication network. The electronic processing device is programmed to implement the above described method for trading a multi-leg financial instrument.

### BRIEF DESCRIPTION OF THE DRAWINGS

Preferred embodiments of the invention will now be described in further detail. Other features, aspects, and advantages of the present invention will become better understood with regard to the following detailed description, appended claims, and accompanying drawing (which are not to scale) where:

FIG. 1 is a diagrammatic view of a computer-implemented apparatus suitable for defining and executing a multi-leg financial instrument;

FIG. 2 is a function block diagram of a programmable processing device shown in FIG. 1;

FIGS. 3A and 3B, collectively, are a flow diagram of a method for creating a multi-leg instrument;

FIG. 4 is a screenshot of a screen for defining a multi-leg instrument and market data for the multi-leg instrument;

FIG. 5 is a screenshot of a screen for adding a leg instrument to the market data generation formulas of FIG. 4;

FIG. 6 is a screenshot of a screen for selecting operators to include in the market data generation formulas of FIG. 4;

FIG. 7 is a screenshot of a screen for selecting analytics to include in the market data generation formulas of FIG. 4;

FIG. 8 is a screenshot of a screen for adding a non-leg instrument to the market data generation formulas of FIG. 4;

FIGS. 9A-9F, collectively, are a flow diagram showing a process of executing a multi-leg instrument;

FIG. 10 is a screenshot of a graphical user interface for trading a multi-leg instrument;

FIG. 11 is a screenshot of a screen showing market data and resting trade orders for three native leg instruments that comprise a multi-leg instrument; and

FIG. 12 is a screenshot of a screen showing a multi-leg order clerk for monitoring and controlling trade orders related to execution of a multi-leg instrument.

### DETAILED DESCRIPTION OF THE PREFERRED EMBODIMENT

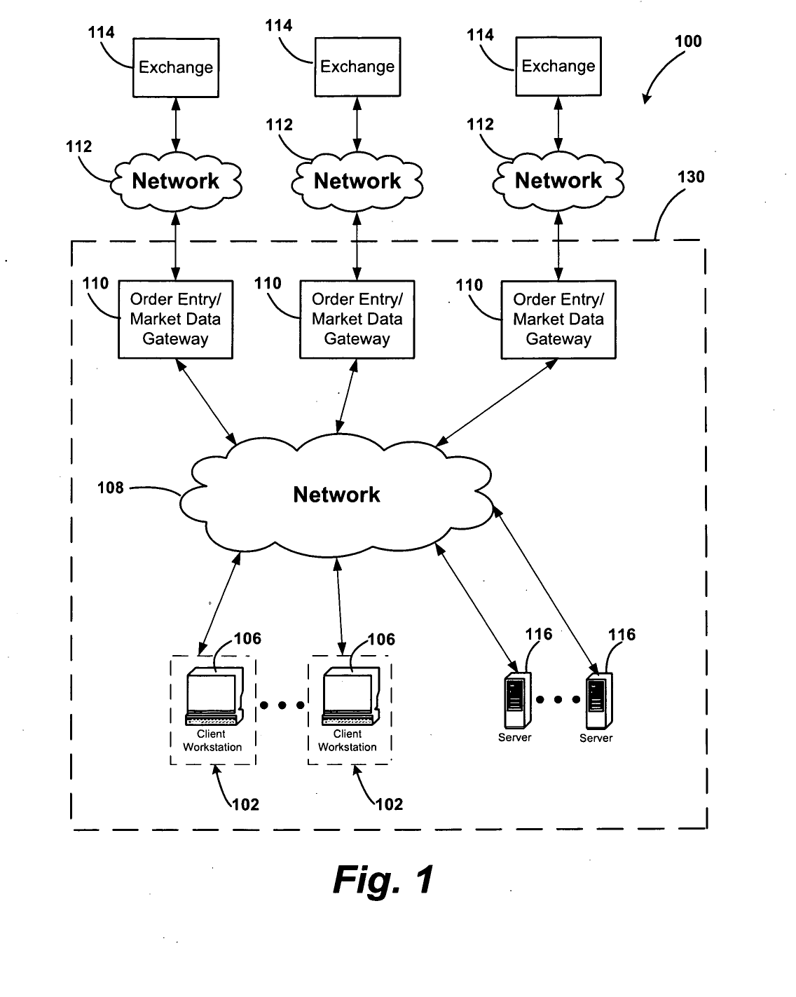

Turning now to the drawings wherein like reference characters indicate like or similar parts throughout, FIG. 1 shows a computer-implemented apparatus 100 suitable for defining and trading a multi-leg financial instrument. The apparatus 100 and the method implemented thereby facilitate the ability of traders to successfully implement multi-leg trading strategies while minimizing so-called “leg risk” where market conditions inhibit the ability to get all legs filled at favorable prices. Leg risk can occur when one or more legs of the multi-leg instrument are fully or partially filled and one or more remainder legs (i.e., legs that are not fully filled) are unable to get filled at the desired price. Since the success of the multi-leg strategy is largely dependent on getting all legs fully filled at the prices desired by the trader according to the multi-leg strategy, the trader's risk is increased for any unfilled (i.e., either partially unfilled or totally unfilled) when one or more of the unfilled legs are unable to be filled at the strategized leg price. The apparatus 100 and associate method described herein employs a unique multi-attempt approach to reduce leg risk by maximizing queue priority and obtaining favorable fills on remainder legs that result from a fractional-fill first attempt.

It is important to note at the outset that the multi-leg instrument is not an exchange-provided instrument. Rather, it is a synthetic instrument defined by a trader according to the trader's multi-leg trading strategy. The synthetic multi-leg instrument includes two or more legs where each leg represents a financial instrument (leg instrument), a price (leg price) for the financial instrument, and a quantity (leg quantity) of the financial instrument that comprises one unit of the multi-leg instrument. Being a synthetic instrument, the multi-leg instrument has a synthetic price represented by a multi-leg definition that equates the synthetic price for one unit of the multi-leg instrument to an aggregation of items including but not limited to the leg price and leg quantity of each leg. Each leg of the multi-leg instrument can include any financial instrument that is tradable by price and quantity, including but not limited to native exchange-provided instruments, synthetic instruments, and other multi-leg instruments (i.e., a nested multi-leg instrument).

The apparatus 100 includes one or more client workstations 102 having a graphical user display, a human interaction device (such as a computer monitor with keyboard and/or mouse) and a client processing device (shown collectively at 106), which may be a dedicated client computer for each client workstation 102 as shown in FIG. 1 or a single computing device networked to each of the client workstations 102. Each trader terminal 102 is configured for electronic communication with an electronic exchange 114 by way of a communication network 108, which may be either a totally wired network or one that is configured to enable at least some components to communicate wirelessly. Trade orders submitted from a client workstation 102 are routed through network 108 where order entry gateways and market data gateways 110 for each exchange 114 receive the trade orders and place them in the proper electronic format according to protocol required by the particular exchange 114. Order entry/market data gateways 110 may be optionally installed in separate hardware, such as one or more servers 116 that are components of network 108, or gateways 110 may be installed in the client workstations 102. The client workstations 102, network 108, servers 116 and order entry and market data gateways 110 are typically elements within the trader's system 130, while networks 112 and exchanges 114 are external to the trader's system. Trade orders are received by an exchange 114 via a communication network 112. A live market data feed 110 is provided to enable traders to view and/or utilize live market data as needed to implement a trader's strategy.

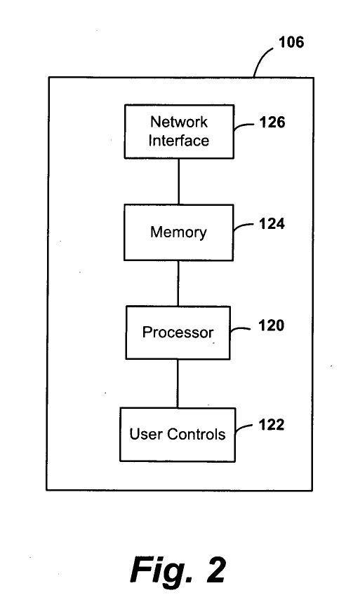

FIG. 2 shows the basic hardware associated with each of the client processing devices 106 shown in FIG. 1. The device 106 includes a programmable electronic processing device 120 (such as a dual quad core Xeon™ E-5420 processing device provided by Intel™) in communication with the display device 104 (FIG. 1), a user input device 122 (such as a computer mouse with buttons and/or a computer keyboard), and a network interface 126 for sending and receiving communications from network 108 (FIG. 1). The client processing device 106 (or other programmable processing device, such as servers 116, that is in communication with the trader terminal 102 of FIG. 1) is programmed to enable a trader to define a multi-leg instrument and to execute the legs of the instrument on one or more electronic exchanges. Programming for processing device 106 may be stored in electronic memory 124, which may include RAM (random access memory), ROM (read only memory), or other suitable form of memory. Alternatively, programming for defining and trading a multi-leg instrument may implemented in one or more servers 116 that are in communication with device 106 via network 108.

As earlier stated, each multi-leg instrument is comprised of two or more legs where each leg represents a financial instrument, or leg instrument with a leg price and a leg quantity. A multi-leg definition that takes into account the leg price and leg quantity of each leg (as well as other items if desired) is used to determine a synthetic price for the multi-leg instrument. A leg submittal trigger, representing one or more requirements that must be met before a trade order for the leg instrument can be submitted to an exchange, is determined for each leg. While spread trading is normally associated with multi-leg trading strategies, the present invention is not limited to spread trading. The implementation of a variety of multi-leg strategies may be facilitated by the present invention.

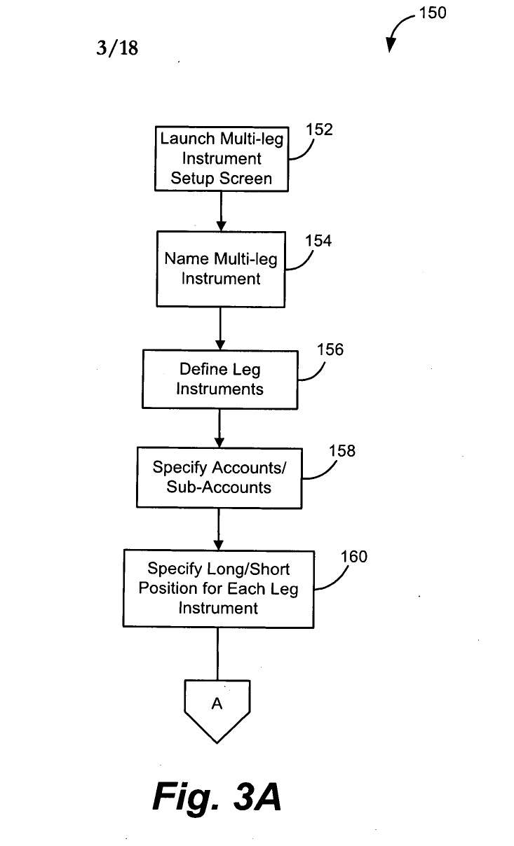

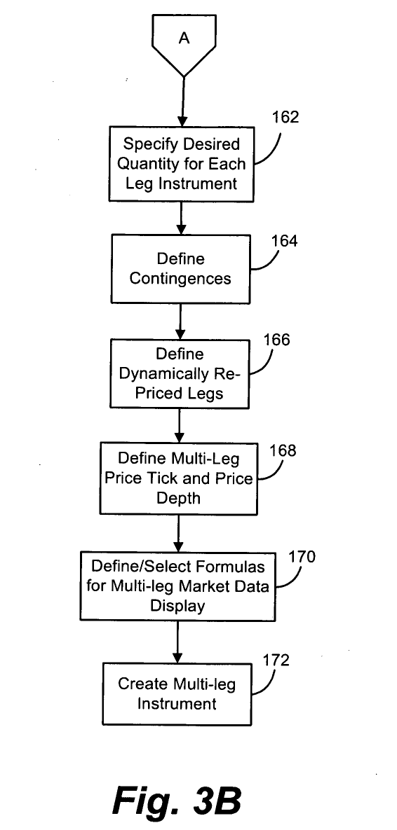

A computer-implemented method 150 for defining a multi-leg instrument to implement a multi-leg trading strategy is shown in FIGS. 3A and 3B. From a trader terminal 102 (FIG. 1), the trader launches a multi-leg setup screen or GUI (graphical user interface) 152 which the trader uses to define various parameters/characteristics of a multi-leg instrument having two or more legs where each leg represents a financial instrument, or leg instrument. Using the setup screen, the trader names the multi-leg instrument 154, defines each leg instrument 156, and optionally specifies accounts and sub-accounts 158 for each leg. The trader also specifies either a long or short position for each leg instrument 160, specifies a desired leg quantity for each leg instrument 162, and defines which leg instruments (if any) will be contingent on the execution of other leg instruments (if any) 164. The trader also defines whether any leg instruments will be dynamically re-priced when market updates are received 166.

With continued reference to FIGS. 3A and 3B, a price tick and price depth are preferably defined to enable generation of an aggregated market data display of the synthetic multi-leg instrument 168. If a multi-leg market data display is to be generated, algorithms for generating the synthetic multi-leg market data are defined/selected 170. Finally, the multi-leg instrument is created 172.

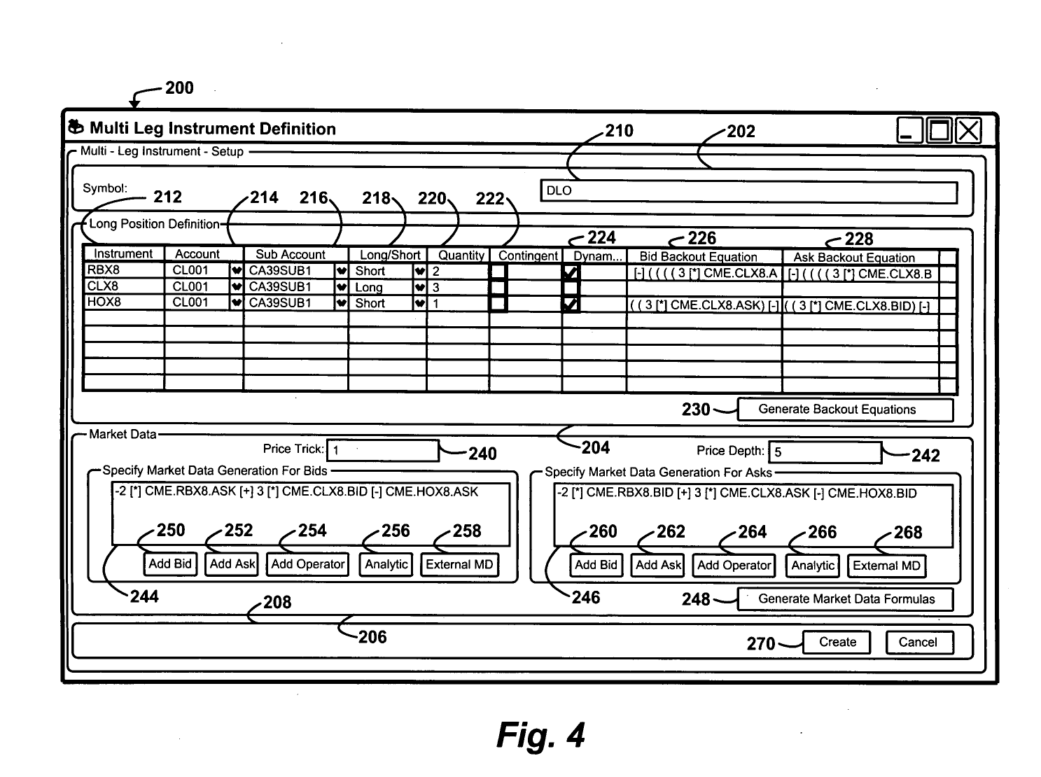

In an exemplary implementation of the multi-leg instrument definition process of FIGS. 3A and 3B, FIG. 4 shows a screenshot of a multi-leg instrument definition screen 200 that is presented at a trader terminal 102 (FIG. 1) when the trader launches a multi-leg instrument setup process. In a preferred embodiment, screen 200 is launched in conjunction with or as an integral component of a trading platform (such as the ACTrader™ trading platform, which is available for license from TradeHelm, Inc. of Tulsa, Okla.) through which trade orders for the multi-leg instrument are submitted to one or more electronic exchanges. The multi-leg instrument definition screen 200 shown in FIG. 4 is divided into four user input areas, including an instrument naming area 202 for naming the multi-leg instrument being created, a multi-leg unit definition area 204 for defining the financial instrument and characteristics of the financial instrument that will comprise each of the two or more legs, a market data definition/generation area 206 for defining market data generation at the multi-leg instrument level, and a multi-leg instrument creation/cancellation area 208 that allows the trader to either create the multi-leg instrument as defined by areas 204, 206 and 208, or to cancel same.

The trader names the multi-leg instrument in Symbol field 210. For this example, the trader has named the multi-leg instrument “DLO”. In multi-leg unit definition area 204, the trader defines each leg of the multi-leg instrument/unit. Here, the trader has defined three legs with each leg including a financial instrument as specified in Instrument column 212. An Account and Sub-Account on which each leg will be traded may be designated in columns 214 and 216, respectively. Long/Short column 218 allows the trader to specify the position each leg instrument will assume when a trade order is submitted using the multi-leg instrument. A Quantity column 220 is provided for specifying the quantity of each leg instrument to be traded. Contingent column 222 provides the trader with the option to make a leg instrument dependent upon another leg instrument such that a trade order for a contingent leg instrument will not execute until trade orders for all dependent leg instruments are executed. This feature is particularly useful in situations where a leg instrument is traded in a less liquid market than the other leg instrument. By making the more liquid leg instrument(s) contingent on execution of the less liquid instrument, the trader increases the likelihood of getting all leg instruments filled. At least one leg must be non-contingent. In the event the trader attempts to make all legs contingent, the apparatus 100 will present the trader with a pop-up window or other message advising that at least one leg instrument must be non-contingent. If the trader wishes to have pricing dynamically re-calculated as market conditions change, the trader may indicate such in Dynamic Recalculation column 224. As described in greater detail below, dynamic re-calculation/re-pricing enables resting trade orders for leg instruments to be re-priced or adjusted when a market update is received via a market data feed 110. Accordingly, backout equations for pricing both the Bid and Ask sides for each leg instrument configured for dynamic re-pricing must be specified in columns 226 and 228, respectively. When a market update is received, the backout equations are used to determine a new/updated leg price.

While the Bid and Ask backout equations for columns 226 and 228 may be defined by the trader, in a preferred embodiment these equations are programmatically determined by solving a multi-leg definition representing a synthetic price of the multi-leg instrument as a function of an aggregation of items that include the leg prices and leg quantities. Accordingly, a synthetic price for the multi-leg instrument can be represented by the following multi-leg definition for the DLO instrument that equates one unit of the synthetic DLO instrument to an aggregation of items including the leg price and leg quantity of each leg:

MLprice=−2A+3B−1C

where:

A=Best Ask price for leg instrument RBX8 at the desired quantity of 2 (since RBX8 has a “short” position, Best Ask is used to represent a “sell” price);

B=Best Bid price for leg instrument CLX8 at the desired quantity of 3 (since CLX8 has a “long” position, Best Bid is used to represent a “buy” price); and

C=Best Ask price for leg instrument HOX8 at the desired quantity of 1 (since HOX8 has a “short” position, Best Ask is used to represent a “sell” price). Solving the above multi-leg definition for each leg instrument price yields the following backout equations for the three legs:

A=(−MLprice+3B−1C)/2;

B=(MLprice+2A+C)/3; and

C=−MLprice−2A+3B.

These backout equations are used to calculate the leg instrument prices including dynamically re-priced legs, and for dynamically re-priced legs they are re-calculated each time a market update is received for any instrument price that is included in the backout equation. The above backout equations are generated programmatically by processing device 106 when the trader clicks the Generate Backout Equations button 230. If desired, the trader can edit or otherwise adjust the automatically generated backout equations.

Market data definition and market data generation for the multi-leg instrument are defined at area 206. Market data definition includes defining the multi-leg instrument book by specifying a Price Tick at field 240 and a Price Depth at field 242, while market data generation determines how the book will appear based on user-defined/specified market data computational formulas made for the Bid and Ask sides in fields 244 and 246, respectively. These computational formulas can use a combination of Bid/Ask market data, user-defined/specified analytics, and external market data. The formulas combine with the market data definition to produce all the parameters needed to generate a graphical user trading interface for the synthetic multi-leg instrument.

When defining market data generation in fields 244 and 246, the trader may define the computational formulas by use of the rows of buttons located below fields 244 and 246. Alternatively, the trader may have processing device 106 auto-generate the computational formulas by simply clicking the Generate Market Data Formulas button 248. When automatic generation of the formulas is used, the formulas are automatically generated from the multi-leg unit definition parameters specified in definition area 204. The trader can also edit or otherwise adjust the automatically generated formulas if desired. For example, using the parameter settings shown in definition area 204, it can be seen that the multi-leg instrument is comprised of three financial instruments (as shown in column 212), including instruments represented by the symbols RBX8 (Gas/Oil Futures Contract), CLX8 (Light Sweet Crude Oil Futures Contract) and HOX8 (Heating Oil Futures Contract). It can further be seen that the desired position for RBX8 is “short” and the desired quantity is “2”, the desired position for CLX8 is “long” and the desired quantity is “3”, and the desired position for HOX8 is “short” with a desired quantity of “1”. In a sense, the generated formulas for both Bid (field 244) and Ask (field 246) are an aggregation of the three legs and/or any other items the trader desires to include. A short position is in inverse relation to a long position, and this inverse relationship is reflected in the formulas by assigning a negative value to a leg that has a short position and a positive value to a leg that has a long position. For each leg having a short position, the Bid formula of field 244 multiplies the negative of the value shown in Quantity column 220 by the Best Ask price for the leg instrument. And for each leg having a long position, the Bid formula of window 244 multiplies the positive of the value shown in Quantity column 220 by the Best Bid price for the leg instrument. Applying the above, the auto-generated market data generation formula for the Bid side is as follows:

−2(CME.RBX8.ASK)+3(CME.CLX8.BID)−1(CME.HOX8.ASK)

where:
CME.RBX8.ASK=Best Ask (for leg instrument RBX8);
CME.CLX8.BID=Best Bid (for leg instrument CLX8); and
CME.HOX8.ASK=Best Ask (for leg instrument HOX8).
   The market data generation formula for the Ask side is as follows:

−2(CME.RBX8.BID)+3(CME.CLX8.ASK)−1(CME.HOX8.BID)

where:
CME.RBX8.BID=Best Bid (for leg instrument RMX8);
CME.CLX8.ASK=Best Ask (for leg instrument CLX8); and
CME.HOX8.BID=Best Bid (for leg instrument HOX8).

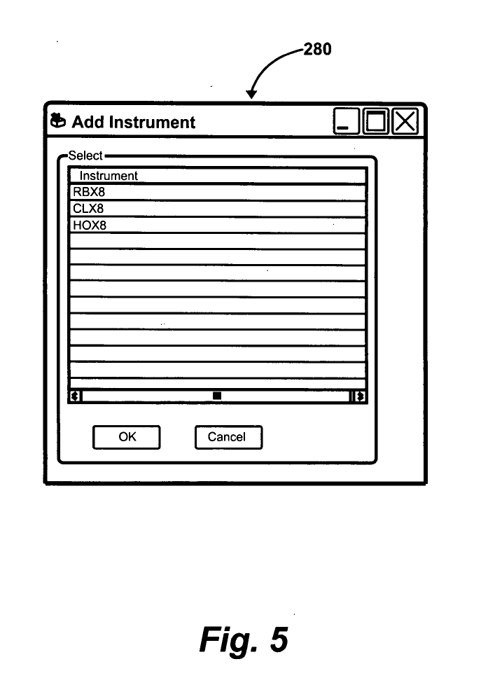

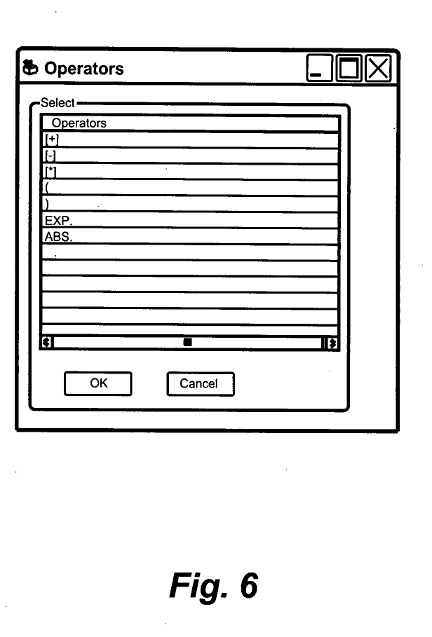

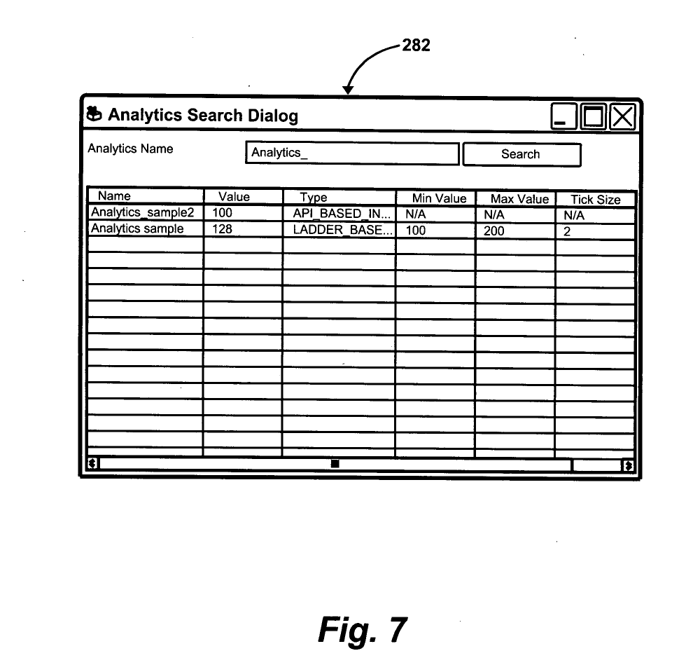

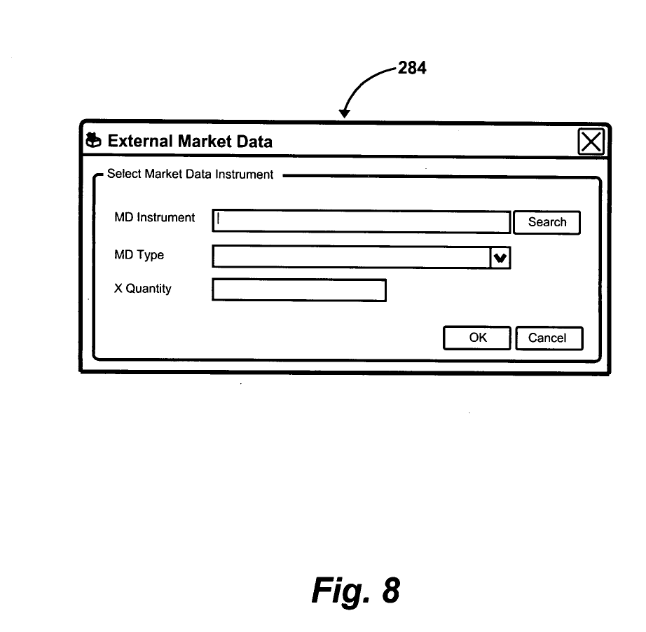

If the trader chooses to define the market data generation formulas, the trader may do so with the use of the buttons located below fields 244 and 246. When the trader clicks either of the Add Bid buttons 250, 260 or the Add Ask buttons 252, 262, an “Add Instrument” window 280 appears as shown in FIG. 5. The trader can then choose to include market data from one of the listed instruments and it will be added to the market data generation equation in field 244 (when building a formula for the Bid side) or field 246 (when building a formula for the Ask side). Logical operators, including + (addition), − (subtraction), * (multiplication), open parenthesis “(”, close parenthesis “)”, EXP (exponential), and ABS (absolute value), are added to the formulas by clicking the Add Operator button 254, 264 and then choosing from the displayed operators shown in FIG. 6. Clicking the Analytics button 256, 266 opens an “Analog Search Dialog” window 282 as shown in FIG. 7 where the trader can choose from a list of previously created user-defined analytics, or alternatively, to create a new analytic. Selecting the External MD (market data) button 258, 268 opens an “External Market Data” window 284 as shown in FIG. 8, where the trader can choose to include external market data from any existing native, synthetic or multi-leg instrument.

Upon completion, the trader clicks Create button 270 to create the multi-leg instrument as defined. At this point, both the Bid and Ask side market data generation fields 244, 246 should contain formulas. If one or both of the formulas are not entered, processing device 106 will generate an error message and not allow the multi-leg instrument to be created until the necessary input has been made.

A preferred method of executing the multi-leg instrument in accordance with programming for processing device 106 or other suitable processing device will now be described. With the multi-leg instrument created, processing device 106 is programmed to execute the multi-leg instrument in accordance with a method intended to maximize the likelihood of successfully filling all legs at favorable prices and low exchange fees while minimizing leg risk. The precise method of execution will vary according to how the multi-leg instrument is configured, particularly with regard to leg submittal triggers which represent one or more requirements that must be met before a trade order for the leg instrument can be submitted to an exchange. Leg submittal triggers include configuring the leg for dynamic re-pricing (see column 224 of FIG. 4), which is essentially a “no wait” requirement that immediately submits a limit trade order to an exchange at a leg price and for the full leg quantity upon initiating execution of the multi-leg instrument. By queuing DLO legs quickly, queue priority is maximized, which increases execution speed and minimizes leg risk. Another example of a leg submittal trigger is a contingent (see column 222 of FIG. 4), which essentially is a “wait” requirement that delays submittal of a trade order until all contingency requirements have been met. A common contingency requirement is to make the submittal of a trade order contingent on all other non-contingent legs having been fully filled. This type of leg submittal trigger is particularly useful in reducing leg risk when the contingent leg is in a more liquid market than the non-contingent legs. Trade orders for contingent legs (including legs configured for dynamic re-pricing) are held in abeyance until all contingencies have been met. Trade orders for non-contingent dynamically re-priced legs are submitted immediately at a desired leg price and quantity. For legs that are non-contingent and non-dynamically re-priced, the leg submittal trigger is essentially a “wait” requirement that delays submittal of a trade order for the leg instrument until current market activity shows that each leg is available at the leg price and leg quantity. Trade orders for these legs are preferably internally queued and submitted to an exchange (such as an electronic exchange, ECN, or broker) when the market crosses the leg price and quantity of the multi-leg instrument (i.e., when current market data reflects that the multi-leg instrument, and hence all legs thereof, is available for acquisition at the desired leg price and quantity). By “internally queue”, what is meant is that the parameters of the trade order (including price, quantity, and order type) are set by processing device 106 such that the trade order can be quickly and efficiently submitted to an exchange when all required conditions have been met. Each leg of the instrument is considered to be “available” when current market activity shows that the specified leg quantity of the respective trade order can be fully filled at a current market price that is equal to or more favorable than (i.e., at or above a desired Ask price and at or below a desired Bid price) the leg price. By placing orders when the market crosses, the trader greatly increases the likelihood of getting all leg orders filled for the full quantity so that leg risk is minimized. For non-continent, dynamically re-priced legs, the leg submittal trigger is essentially a “no wait” requirement that immediately submits a trade order to an exchange at the leg price and leg quantity upon initiating execution of the multi-leg instrument. For any leg which is not fully filled after an initial trade order for that leg is submitted, a subsequent trade order will be sent for the remaining leg quantity at a leg price that is determined based on the fill price of all fully and partially filled legs, provided the multi-leg instrument is still available at a favorable price.

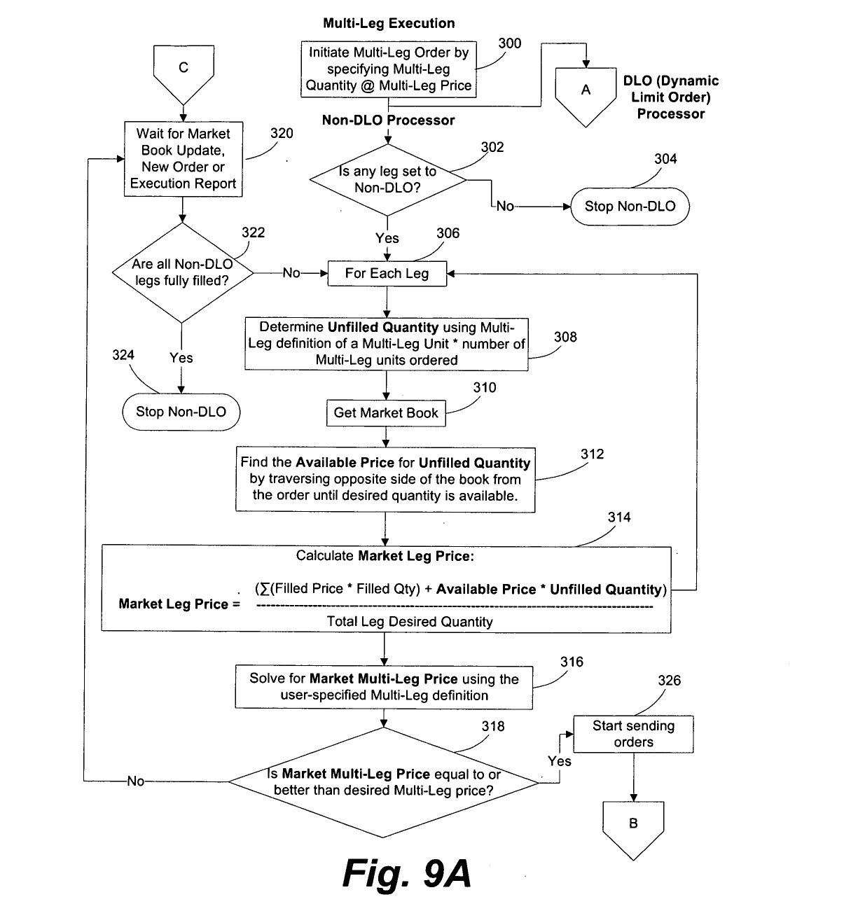

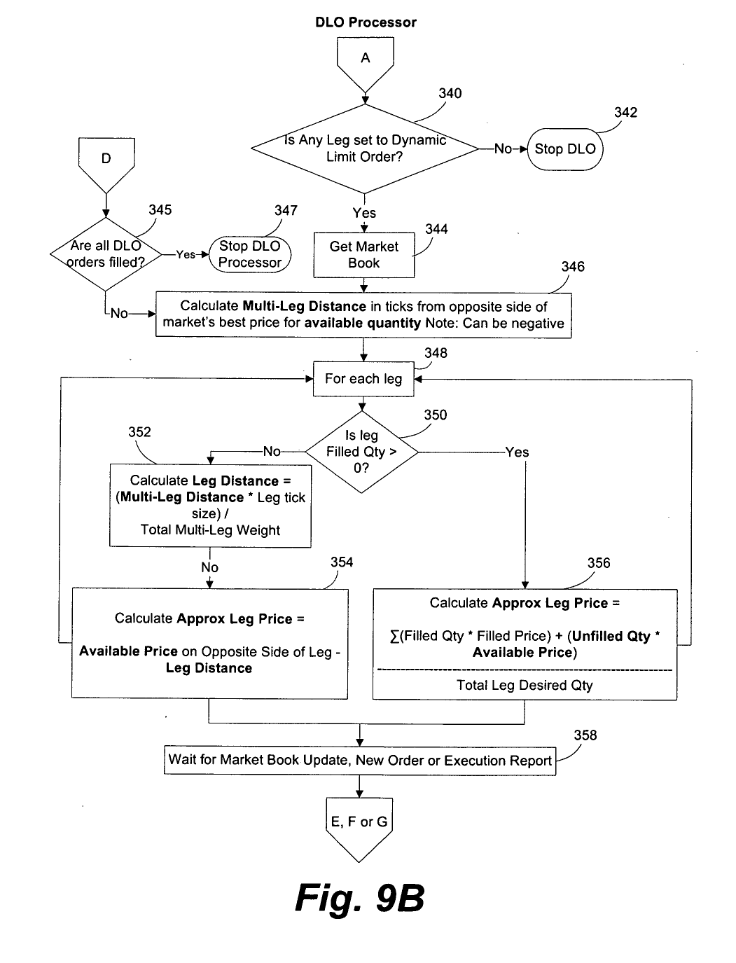

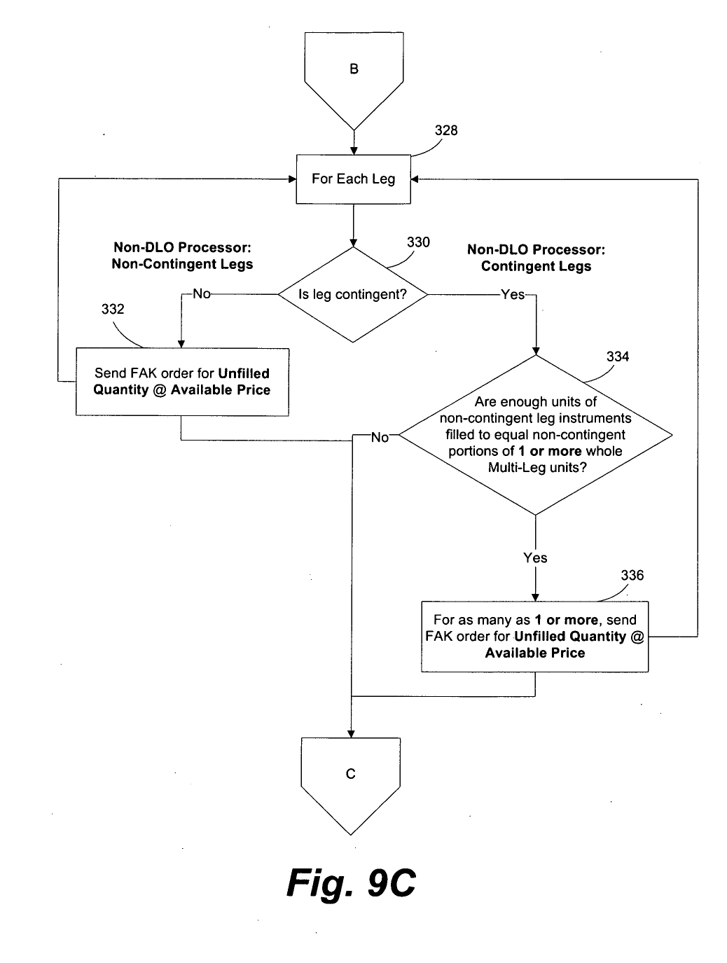

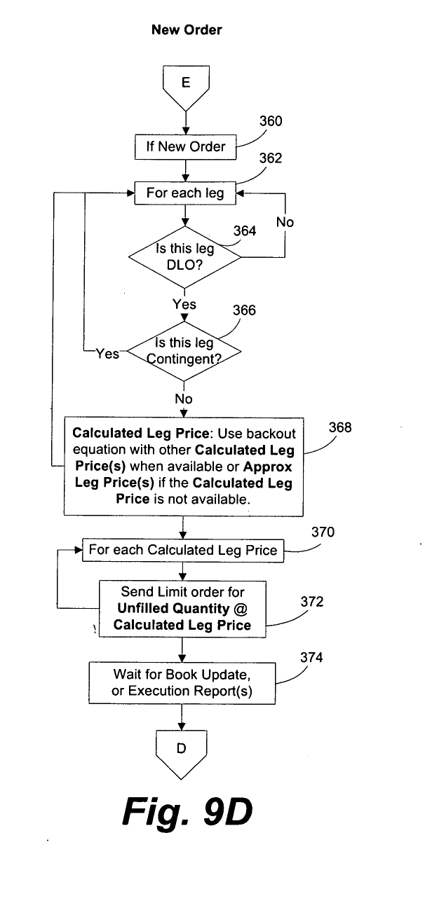

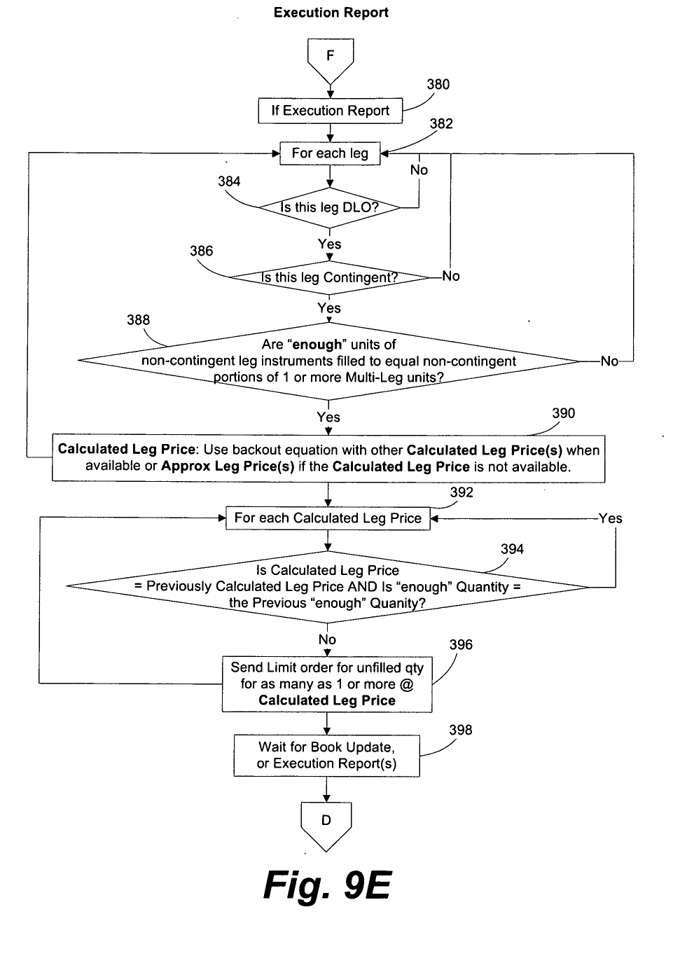

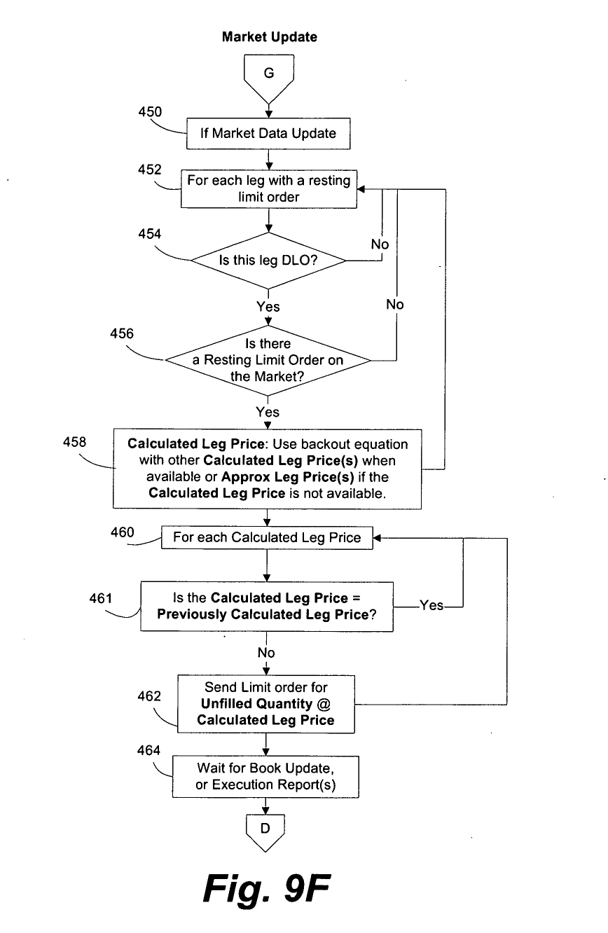

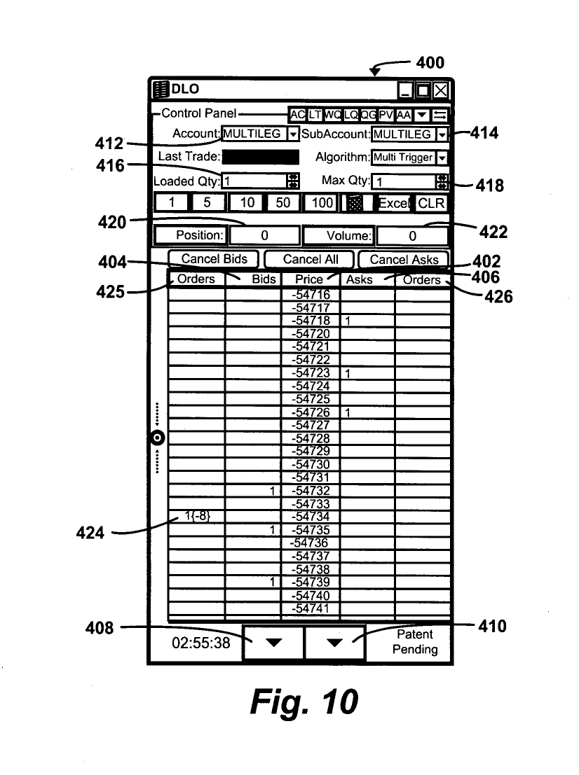

Multi-leg execution can be further understood with reference to the flow diagram of FIGS. 9A-9F. The trader initiates execution of the multi-leg instrument by placing a multi-leg order for a specified synthetic multi-leg price and for a specified multi-leg quantity 300. In a preferred embodiment, this is accomplished by use of the multi-leg trading ladder shown in FIG. 10, as described more fully below. The execution process proceeds along two leg execution paths, including a DLO (Dynamic Limit Order) path (beginning in FIG. 9B) for executing legs that are configured for dynamic re-pricing, and a non-DLO path (beginning in FIG. 9A) for executing legs that are not configured for dynamic re-pricing. As discussed above, one or more legs may be configured for dynamic re-pricing (i.e., DLO) at column 224 of FIG. 4. The non-DLO leg execution process begins by checking to see whether any leg is not configured for dynamic re-pricing 302. If no legs are configured for non-dynamic re-pricing, the non-DLO portion of the multi-leg execution process is terminated 304. For each leg 306 that is not configured for dynamic re-pricing (i.e., a non-DLO leg), the execution process proceeds to determine an Unfilled Quantity for the leg using the multi-leg definition 308. The Unfilled Quantity will be equal to the total unfilled leg quantity for all units of the multi-leg instrument specified at step 300. The current market book for the leg instrument is obtained 310, and a current Available Price for the Unfilled Quantity is determined by traversing the opposite side of the book from the intended leg order until the Unfilled Quantity is available 312, taking the price where the needed quantity is found by summing each quantity at each price level starting at the inside market and traversing away from the market (up for Asks, down for Bids). The Available Price will be the worst price (i.e., highest for a Bid, lowest for a Sell) that must be paid in order to obtain the Unfilled Quantity. For example, if the leg has a “long” position with an Unfilled Quantity of 7, and there are 2 units of the leg instrument available on the Ask/Sell side of the book at a price of 100, 3 units available at a price of 101, and 8 units available at a price of 102, then the Available Price is 102 because the market book reflects that a trade order for the Unfilled Quantity of the leg instrument must be placed at a price of 102 in order to get all of the Unfilled Quantity filled. In this example, a limit order for 7 units of the leg instrument at a price of 102 is expected to result in 2 units filled at a price of 100, 3 units filled at a price of 101, and 2 units filled at a price of 102 with a VWAP (Volume Weighted Average Price) of 101 for the 7 units.

With the Available Price and Unfilled Quantity determined, a current Market Leg Price is calculated 314. In a preferred embodiment, Market Leg Price is determined according to the following equation:

$$Market Leg Price = \frac{\begin{matrix}( \sum ( Filled Price * Filled Qty ) + \\ Available Price * Unfilled Qty )\end{matrix}}{Total Leg Desired Qty}$$

This equation adds the sum of the product of any filled leg quantity(ies) and the price(s) paid with the product of the Available Quantity and the Unfilled Quantity, divided by the total desired quantity of the leg instrument. Total Leg Desired Qty is determined by multiplying quantity of multi-leg units specified at step 300 by the leg quantity value specified in column 218 of FIG. 4. After steps 306-314 have been performed for each non-DLO leg, a Market Multi-Leg Price is calculated using the trader-specified multi-leg definition and the Market Leg Price calculated for each non-DLO leg 316.

The non-DLO leg execution process compares the Market Multi-Leg Price with the desired multi-leg price 318 specified at step 300. If the current Market Multi-Leg Price is not equal to or more favorable than the desired multi-leg price specified at step 300, the process waits for a market book update, new trade order or execution report 320. When any of these events occurs, the process checks to see whether all non-DLO legs are fully filled 322. If not, the non-DLO leg execution process repeats from step 306. When all legs are fully filled, the non-DLO process stops 324. If there are still unfilled non-DLO legs remaining, the process starts again at step 306.

At step 318, when the current Market Multi-Leg Price is equal to or more favorable than the desired multi-leg price specified at step 300 (i.e., the market has crossed the multi-leg instrument), the process recognizes the market data as showing that each leg instrument is available at the desired quantity and a price that is sufficiently favorable to meet or best the synthetic multi-leg price specified at step 300. So the process starts sending trade orders for the non-DLO legs 326. At this point for each leg 328, the process determines whether the leg is contingent 330. A leg can be made contingent on any one or more requirements that must be met before a trade order for the leg instrument can be submitted to an exchange, and in this manner, the contingency requirements function as a leg submittal trigger. A typical example of a contingency is where the leg is made contingent on one or more other legs being fully filled. In this example, trade orders for the contingent leg cannot be submitted until the one or more other legs have been fully filled where “fully filled” means all leg quantity defined for a single multi-leg unit has been filled.

If the leg is found to be not contingent at step 330, an FAK (Fill And Kill) order is submitted to an electronic exchange for the Unfilled Quantity of the leg instrument at the Available Price 332. After FAK orders have been sent for all non-DLO legs that are not contingent, the process proceeds to step 320 and waits for a market book update, new order or execution report. For each leg found to be contingent at step 330, the process determines whether there are “enough” units of non-contingent leg instruments filled to equal all non-contingent portions of one or more whole multi-leg units 334. For example, if the multi-leg instrument includes 4 leg instruments, 2 of which are contingent on all non-contingent legs being fully filled, and 1 unit of the multi-leg instrument requires 5 units for each of the 2 non-contingent leg instruments, then the value of “enough” will be 5 units or more for each of the 2 non-contingent leg instruments. If each of the 2 non-contingent legs had filled quantities of 10 units, there would be enough filled quantity of the non-contingent leg portions for 2 multi-leg units. So, having a filled quantity of at least 5 units for each of the 2 non-contingent legs would meet the criteria of step 334, and the process would move to step 336. If either of the 2 non-contingent legs had filled quantities of less than 5 units (which is not enough non-contingent leg instrument fills to satisfy 1 unit of the multi-leg instrument), then the criteria of step 334 would not be met, and the process would proceed to step 320 and wait for a market book update, new order or execution report.

At step 336, for as many as the “1 or more” multi-leg units determined at step 334, the process submits an FAK order to an electronic exchange for the Unfilled Quantity at the Available Price. After FAK orders have been sent for all contingent non-DLO legs, the process proceeds to step 320 and waits for a market book update, new order or execution report.

With reference now to the DLO leg execution process beginning at the top of FIG. 9B, the process performs an initial check to determine whether any leg is configured for dynamic re-pricing/DLO 340. If not, the DLO execution process stops 342. Otherwise, the process proceeds to obtain the aggregated market book for the multi-leg instrument 344, from which a synthetic market book for the multi-leg instrument is created as previously discussed above and as further discussed below with reference to the multi-leg trading ladder of FIG. 10. While the step of obtaining market book data is shown at particular points in the flow diagram of FIGS. 9A-9F, it should be noted that market data may be obtained for both the DLO leg execution process and the non-DLO leg execution process, or any individual leg(s), at any point in time prior to when that data is needed.

Using the market data, the process calculates a Multi-Leg Distance, which is the number of ticks that separate the market's best price for the needed quantity on the opposite side of the book from the multi-leg order's price 346 as specified at step 300. For example, if the leg being processed at step 346 is designated as “long” at column 218 of FIG. 4, then the leg side of the book will be the Bid side and the opposite side of the book will be the Ask side. If the leg calls for 5 units of the leg instrument for each multi-leg instrument unit and only 1 unit of the multi-leg instrument was specified at step 300, then the Multi-Leg Distance is measured as the number of ticks that separate the best price for any quantity on the Bid side of the book from the market's best price for an available quantity of 5 on the Ask side of the book.

After calculating Multi-Leg Distance, the process proceeds to step 348 where for each leg, the process determines whether the leg's filled quantity is greater than zero 350 (i.e., whether the leg is partially or fully filled). If it is, an Approximate Leg Price is calculated at step 356 by the following equation:

$$Approx Leg Price = \frac{\begin{matrix}( \sum ( Filled Qty * Filled Price ) + \\ Unfilled Qty * Available Price )\end{matrix}}{Total Leg Desired Qty}$$

This equation adds the sum of the product of any filled leg quantity(ies) and the price(s) paid with the product of the Available Quantity and the Unfilled Quantity for the leg, divided by the total desired quantity of the leg instrument. Total Leg Desired Qty is determined by multiplying the leg quantity value specified in column 218 of FIG. 4 by the quantity of multi-leg units specified at step 300. If it is determined at step 350 that filled leg quantity is not greater than zero, steps 352 and 354 are preferably used to approximate a leg price. However, it should be noted that an approximate leg price can be calculated at step 356 in lieu of step 352-354. At step 352, the process calculates a Leg Distance by use of the following equation:

$$Leg Distance = \frac{( Multi \text{-} Leg Distance * Leg Tick Size )}{Total Multi \text{-} Leg Weight}$$

Total Multi-Leg Weight is the total number of units of the leg instrument needed to fully fill all units of the multi-leg instrument specified at step 300 specified in column 218 of FIG. 4.

An Approximate Leg Price is calculated at step 354 by the following equation:

Approx Leg Price=Available Price on the opposite side of the book from the leg−Leg Distance

The result of this equation can be negative in cases where the multi-leg order was placed crossing the multi-leg market. After steps 348-356 have been performed for each DLO leg, an approximate leg price has been determined for each leg and the DLO process then proceeds according to the occurrence of an event—a market book update, new order, or execution report 358. For a new multi-leg order, the process proceeds as shown in FIG. 9D. If an execution report is received, the process proceeds as shown in FIG. 9E. If a market update is received, the process proceeds as shown in FIG. 9F.

Since a new order for the multi-leg instrument occurs only once (i.e., when the execution process is initiated at step 300), the process will complete the new order processing steps 360-374 only once. And the new order must be processed (steps 360-374) before any processing occurs after receiving an execution report (FIG. 9E) or market data update (FIG. 9F). After new order processing has occurred (steps 360-374), if an execution report and market data update are received concurrently, the execution report is given priority and processed according to steps 380-396 of FIG. 9E before the market data update is processed according to steps 450-462 of FIG. 9F.

Referring to FIG. 9D, if a new order has been placed for a multi-leg instrument 360, then for each leg 362, the process first confirms that the leg is a DLO leg 364 and not contingent 366 or else the process moves on to process the next leg. Once confirmed, a Calculated Leg Price is determined 368 for each confirmed leg using the appropriate backout equation specified at columns 226 and 228 of FIG. 4. If the trader has initiated a Bid order to buy one unit of the multi-leg instrument at step 300, the process uses the Bid backout equation defined in column 226 of FIG. 4 to determine the Calculated Leg Price. If the trader has initiated an Ask order to sell one unit of the multi-leg instrument, the process uses the Ask backout equation defined in column 228 of FIG. 4 to determine the Calculated Leg Price. Calculated Leg Price is determined for each non-contingent, DLO leg. Prices used in the backout equation preferably use the Calculated Leg Price of other legs if available. If no Calculated Leg Price is available for a leg, then the backout equation should use that leg's Approximate Leg Price. This is preferred because by using calculated instead of approximated leg prices, the relative price difference between legs is held constant. When the calculated values for other legs are used, the under-determined multi-variate equations become more determined in this way.

For each Calculated Leg Price determined at step 368, a limit order is sent for the Unfilled Quantity of the leg at the Calculated Leg Price 372. After all limit orders for all non-contingent DLO legs have been sent, the process waits for a book update or an execution report 374 and then checks to see whether all DLO legs have been filled 345. If all DLO legs are filled, the DLO leg execution process is terminated 347. Otherwise, the process moves to step 346.

If an execution report 380 is received at step 358, the process proceeds as shown in FIG. 9E. For each leg 382, the process first confirms that the leg is a DLO leg 384 and is contingent 386 as all non-contingent DLO legs are initially processed at steps 360-374 of the DLO leg execution process. Once confirmed, the process determines whether there are “enough” units of non-contingent leg instruments filled to equal all non-contingent portions of one or more whole multi-leg units 388. If there are not enough units filled at step 388, the process returns to step 382 and repeats. When enough units are filled, a Calculated Leg Price is determined 390 for the leg instrument using the appropriate backout equation specified at columns 226 and 228 of FIG. 4. If the trader has initiated a Bid order to buy one unit of the multi-leg instrument at step 300, the process uses the Bid backout equation defined in column 226 of FIG. 4 to determine the Calculated Leg Price. If the trader has initiated an Ask order to sell one unit of the multi-leg instrument, the process uses the Ask backout equation defined in column 228 of FIG. 4 to determine the Calculated Leg Price. Calculated Leg Price is determined for each contingent, DLO leg. Prices used in the backout equation preferably use the Calculated Leg Price of other legs if available. If no Calculated Leg Price is available for a leg, then the backout equation should use that leg's Approximate Leg Price.

Once all legs have a Calculated Leg Price, then for each Calculated Leg Price 392 determined at step 390, the process determines whether the Calculated Leg Price is equal to the immediately preceding Calculated Leg Price and whether there is “enough” filled quantity of non-contingent legs to equal one or more whole multi-leg units 394. If either condition is not true, this indicates that the current Calculated Leg Price does not equal the immediately preceding Calculated Leg Price or a contingency change occurred and adjustments to pre-existing resting limit orders must be made. If both conditions of step 394 are met, the process returns to step 392 and the next Calculated Leg Price for the next leg. If one or more conditions of step 394 are not met, a limit order is sent to an electronic exchange for the Unfilled Quantity of the leg for as many as the “1 or more” multi-leg units determined at step 388 at the Calculated Leg Price 396. After limit orders have been sent for all contingent DLO legs, the process waits for a book update or an execution report 398 and then checks to see whether all DLO legs have been filled 345. If all DLO legs are filled, the DLO leg execution process is terminated 347. Otherwise, the process repeats from step 346.

If a market data update 450 is received at step 358, the process proceeds as shown in FIG. 9F to determine whether any resting limit orders for DLO legs need to be adjusted. For each leg 452, the process first confirms that the leg is a DLO leg 454 and that there is a resting limit order on the market for the leg instrument 456. Once confirmed, a Calculated Leg Price is determined 458 for the leg instrument using the appropriate backout equation specified at columns 226 and 228 of FIG. 4. If the trader has initiated a Bid order to buy one unit of the multi-leg instrument at step 300, the process uses the Bid backout equation defined in column 226 of FIG. 4 to determine the Calculated Leg Price. If the trader has initiated an Ask order to sell one unit of the multi-leg instrument, the process uses the Ask backout equation defined in column 228 of FIG. 4 to determine the Calculated Leg Price. Calculated Leg Price is determined for each DLO leg having a resting limit order on the market. Prices used in the backout equation preferably use the Calculated Leg Price of other legs if available. If no Calculated Leg Price is available for a leg, then the backout equation should use that leg's Approximate Leg Price.

For each Calculated Leg Price 460 determined at step 458, the process determines whether the Calculated Leg Price is equal to the Previously Calculated Leg Price 461. If the new leg price is equal to the old leg price, the process returns to step 460 and processes the next leg. If the new leg price is different, the resting trade order for the leg is adjusted accordingly at step 462 by submitting a new limit order to an electronic exchange for the leg instrument at the new Calculated Leg Price for the Unfilled Quantity. After new limit orders have been sent for all DLO legs with resting limit orders, the process waits for a book update or an execution report 464 and then checks to see whether all DLO legs have been filled 345. If all DLO legs are filled, the DLO leg execution process is terminated 347. Otherwise, the process repeats from step 346.

The particular manner in which resting limit orders are adjusted at step 461 will depend on order entry/messaging policies dictated by each of the various exchanges. For example, some exchanges support a Cancel/Replace (CXR) order, and for those exchanges step 461 could be implemented by submitting a CXR order to a new price level. For exchanges that do not support CXR order messaging, step 461 might be implemented by submitting a Cancel order for the resting limit order(s) and submitting a new limit order at a new price.

It should be noted that for each step of the multi-leg execution process that involves calculating a leg price, the calculated leg price must take into account the price(s) (if any) at which the leg has been filled as well as the extent to which the leg has been filled because once a leg is filled (partially or fully) the fill price is fixed for those legs of the multi-leg instrument that have been filled and that fill price (or prices) becomes a fixed aspect of the multi-leg order processing strategy. To illustrate this by way of example, assume leg instrument CLX8 discussed above has received a partial fill for 2 of the desired 3 units of this instrument at a fill price of X. If the CLX8 leg instrument is partially filled and then re-priced at step 314, the Market Leg Price equation inherently weights the fill price by ⅔ and the new price for the remaining quantity of instrument CLX8 (i.e., 1) by ⅓. If each of the 2 filled units of CLX8 were filled at different prices, then the first fill price is weighted by ⅓, the second fill price is weighted by ⅓, and the new price for the remaining quantity is weighted by ⅓. All legs are re-priced in this manner based on weighted fill prices and fill percentages of any fully or partially filled legs.

In a preferred embodiment, the trader is presented with a graphical user interface (GUI) in the form of a multi-leg trading ladder 400, as shown in FIG. 10, from which execution of a synthetic multi-leg instrument may be launched at step 300 of FIG. 9A. Multi-leg trading ladder 400 includes a central price column 402 showing market prices for the multi-leg instrument as defined by the trader in FIG. 4. A Bids column 404 for displaying units of the multi-leg instrument available on the Bid side is positioned adjacent the left side of price column 402, and an Ask column 406 for displaying units of the multi-leg instrument available on the Ask side is positioned adjacent the right side of price axis 402. While the book depth for trading ladder 400 was defined in field 242 of FIG. 4 as “5”, it is noted that the book depth pictured in FIG. 10 is only 3. The remaining two levels of book depth can be viewed by scrolling the market data down or up using scroll keys 408, 410. Market data can also be scrolled using a keyboard's Page Up and Page Down keys, arrow Up and Down keys, or any other keys configured for scrolling the market data. Accounts/subaccounts through which the multi-leg instrument is to be traded are specified at Account field 412 and Subaccount field 414. Loaded Qty field 416 indicates to the trader the quantity of multi-leg units that will be traded with a single click. A Max Qty field 418 sets a limit on the quantity that can be loaded into the Loaded Qty field 416. In this manner, Max Qty field 418 functions to help ensure the trader does not inadvertently submit trade orders with extraordinarily high quantities. For example, by setting the limit in Max Qty field 418 to a value of “5”, the maximum value that can be placed in the Loaded Qty field 416 is “5”, which prevents the trader from inadvertently submitting a trade order with a quantity greater than 5 units of the multi-leg instrument. A Position field 420 shows the trader's current position, and Volume field 422 shows the volume traded during the trading session.

The trader may initiate execution of the multi-leg instrument in a number of ways, with or without a multi-leg instrument trading ladder. In a preferred embodiment, trading ladder 400 is configured to enable the trader to execute either a Buy or Sell of the multi-leg instrument by a single mouse click. To initiate execution, the trader simply places the mouse curser (or other onscreen pointer) at the desired synthetic price level and clicks the left mouse button (or other comparable user input device) to initiate a Buy of the multi-leg instrument at the moused-over/selected price level. To initiate a Sell of the multi-leg instrument, the trader right clicks at the desired price level. In FIG. 10, the trader has left clicked at synthetic price level −54734 (indicated at reference number 424) to place a Bid order for the multi-leg instrument at that price level. A Bids Orders column 422 shows that the trader has a resting order to buy 1 unit of the multi-leg instrument at the desired price level 424, and that this order is currently resting at 8 ticks below current market price as indicated by the notation “{−8}”. Right clicking at a desired price level that is above current market price (i.e., Best Bid or Best Ask, depending on side selected) will similarly place a resting order to sell 1 unit of the multi-leg instrument in Asks Orders column 426 at the selected price level. Based on the price level clicked at, processing device 106 proceeds to calculate leg prices for each leg instrument by solving the multi-leg definition as described above. Thus, when execution of the multi-leg instrument is initiated with use of trading ladder 400, the trader specifies a synthetic price for the multi-leg instrument and indirectly specifies a desired leg price for each leg instrument.

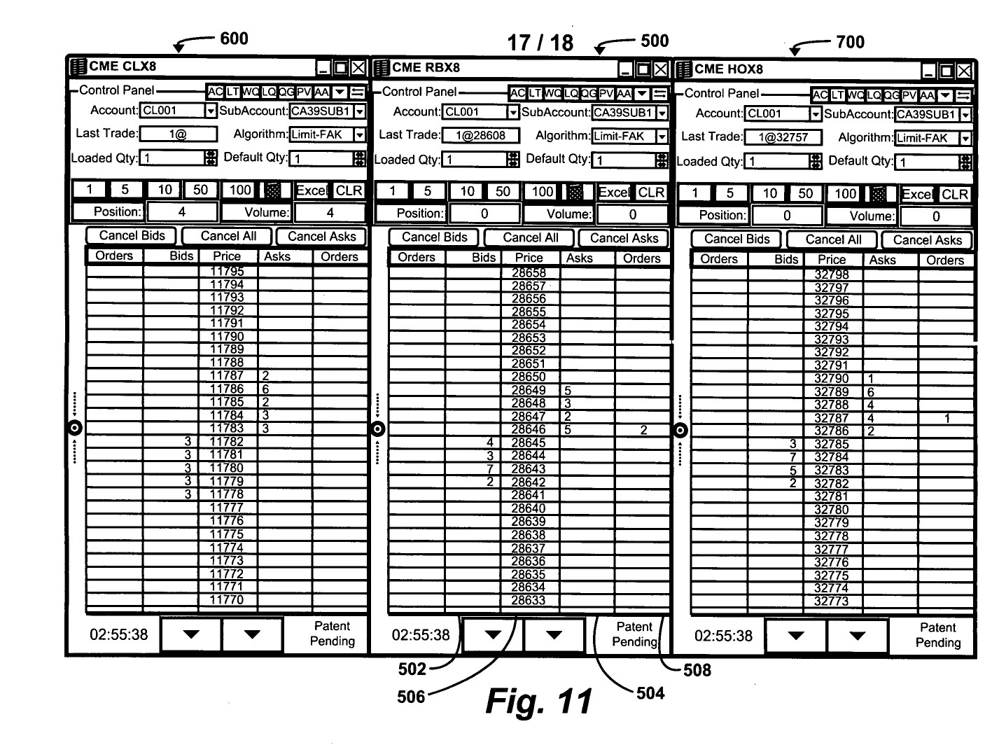

A look at the market data for each of the underlying leg instruments helps to illustrate how the multi-leg instrument definition and execution processes work. FIG. 11 shows a trading ladder 500 for leg instrument RBX8, a trading ladder 600 for leg instrument CLX8, and a trading ladder 700 for leg instrument HOX8. With reference to the multi-leg instrument and market data definitions set forth in FIG. 4, it is noted that the multi-leg instrument includes 2 units of financial instrument RBX8. FIG. 11 shows current market data for RBX8 in the form of resting Bids (Bids column 502) and resting Asks (Asks column 504) at price levels as indicated in Price column 506. Thus, 2 units of RBX8 can be sold at a best price level of 28645 and 2 units of RBX8 can be bought at a best price level of 28646. The multi-leg instrument also includes 3 units of instrument CLX8. The market data for instrument CLX8 shown in trading ladder 600 reveals that 3 units of CLX8 can be sold at a best price level of 11782, and 3 units of CLX8 can be bought at a best price level of 11783. Completing the multi-leg instrument is 1 unit of instrument HOX8. The market data for instrument HOX8 shown in trading ladder 700 reveals that 1 unit of HOX8 can be sold at a best price of 32785, and 1 unit of HOX8 can be bought at a best price level of 32786. The market data provided in FIG. 11 is used to resolve the Bid and Ask market data formulas set forth in windows 244 and 246, respectively, of FIG. 4.

Resolution of the market data formulas can be illustrated by solving the Bid formula (window 244), which is as follows:

−2(CME.RBX8.ASK)+3(CME.CLX8.BID)−1(CME.HOX8.ASK)

Using Best Bid and Best Ask from the market data provided in FIG. 11 yields the following:

−2(28646)+3(11782)−1(32786)=−54,732

A “1” is placed in Bids column 404 of the multi-leg trading ladder 400 to indicate that 1 unit of the multi-leg instrument can be sold at a price level of −54,732. A “1” is also placed in Bids column 404 at a price level of −54,735 to indicate that a second unit of the multi-leg instrument can be sold at the −54,735 price level. The market data generation formula set forth in window 246 of FIG. 4 for the Ask side is similarly resolved from the market data for the leg instruments set forth in FIG. 11, as reflected by the quantities shown in Asks column 406 of FIG. 10. These Bid and Ask market data computations are carried out for the multi-leg instrument to a book depth of “5” as specified in field 242 of FIG. 4.

The multi-leg execution process described herein is also reflected in FIGS. 10 and 11. When the trader left clicked at price level −54,734 of FIG. 10, the execution process immediately submitted a resting Ask limit order for RBX8 at the desired leg price of 28,646 (as determined by the price level 424 clicked in the multi-leg trading ladder 400) and at a leg quantity of “2” (as determined by the value entered in Quantity column 220 of FIG. 4) since the leg for RBX8 is a non-contingent dynamically re-priced leg. The resting limit order can be seen in Asks Orders column 508 of the RBX8 trading ladder 500. In addition, the execution process placed a resting Ask limit order for HOX8 at the desired price of 32787 and at a leg quantity of “1”. No trade order has been submitted for leg instrument CLX8 since it is a non-contingent non-dynamically re-priced leg and the market has not crossed the resting limit order for the multi-leg instrument (as evident in FIG. 10). When the market for the multi-leg instrument crosses price level 424 of the multi-leg trading ladder 400, all legs are available at full leg quantity and desired leg price (or better), and an FAK limit order is submitted for 1 unit of the CLX8 instrument available at a desired leg price level.

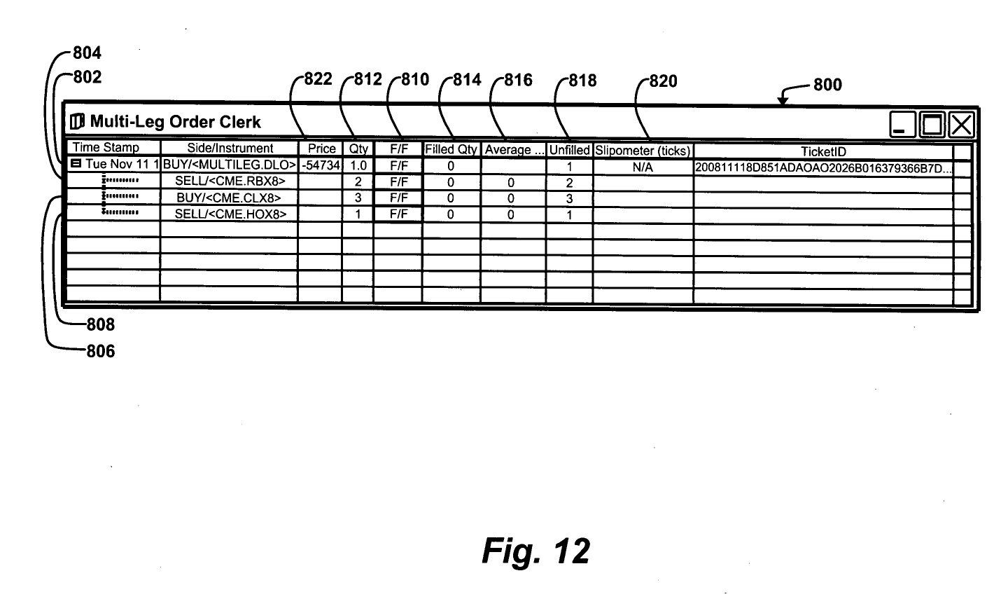

FIG. 12 shows a multi-leg order clerk 800 from which trade orders submitted for each of the leg instruments can be monitored and controlled. The order clerk 800 provides a useful tool for monitoring the synthetic multi-leg instrument and its legs. Trade orders for each leg instrument can be discretely submitted and filled from the order clerk 800 by clicking the fractional fill F/F button in column 810 associated with the appropriate row 802-808. F/F buttons 806 are particularly useful in situations where the multi-leg instrument has been fractionally filled and the trader wishes to obtain a fill on a remainder leg at the current market price. In such a situation, the trader may be looking to cap any loss (or prevent any further decrease in profit) by filling the remainder leg at current market price. Order clerk 800 also shows the trader the desired quantity in column 812, filled quantity in column 814, average fill price in column 816, and remainder quantity in column 818. A Slipometer™ column 820 shows slippage (in ticks) from the desired price shown in Price column 822.

The foregoing description details certain preferred embodiments of the present invention and describes the best mode contemplated. It will be appreciated, however, that changes may be made in the details of construction and the configuration of components without departing from the spirit and scope of the disclosure. Therefore, the description provided herein is to be considered exemplary, rather than limiting, and the true scope of the invention is that defined by the following claims and the full range of equivalency to which each element thereof is entitled.

What is claimed is:

1. A method for trading a multi-leg financial instrument, said method comprising:
defining a multi-leg instrument having two or more legs where each leg represents a financial instrument (leg instrument), a price (leg price) for the financial instrument, and a quantity (leg quantity) of the financial instrument that comprises one unit of the multi-leg instrument, said multi-leg instrument having a synthetic price represented by a multi-leg definition that equates the synthetic price for one unit of the multi-leg instrument to an aggregation of items including the leg price and leg quantity of each leg;
determining a leg submittal trigger for each leg representing one or more requirements that must be met before a trade order for the leg instrument can be submitted to an exchange;
monitoring current market activity for each leg instrument to determine a current status for leg price availability and leg quantity availability;
submitting a first trade order to an exchange at a leg price determined by the multi-leg definition and for the leg quantity for each leg in which the leg submittal trigger is met;
for each leg in which the leg quantity is not fully filled (remainder leg) after any quantity for any leg has been filled, calculating an updated leg price for such remainder leg based on the fill price(s) for all filled and partially filled legs;
sending a subsequent trade order to an exchange for each remainder leg at the updated leg price and for the amount of the leg quantity that remains unfilled (remainder quantity) when the leg submittal trigger for the remainder leg is met; and
repeating said calculating and sending steps until all legs of the multi-leg instrument are fully filled.

2. The method of claim 1 wherein the leg submittal trigger for one or more legs includes a wait requirement that delays submittal of:
the first trade order to an exchange until current market activity shows that each leg is available at the leg price and leg quantity; and
any subsequent trade order to an exchange until current market activity shows that each remainder leg is available at the leg price and remainder quantity.

3. The method of claim 2 wherein:
each leg is available at the leg price and leg quantity when current market activity shows that the leg quantity of the respective trade order can be fully filled at a current market price that is equal to or more favorable than the leg price; and
each remainder leg is available at the updated leg price and at the remainder quantity when current market activity shows that the remainder leg quantity can be fully filled at a current market price that is equal to or more favorable than the updated leg price.

4. The method of claim 1 wherein the leg submittal trigger for one or more legs includes a no wait requirement that immediately submits the first trade order to an exchange.

5. The method of claim 1 wherein the leg submittal trigger for one or more legs includes a contingency requirement that delays submittal of the first trade order to an exchange until all contingency requirements have been met.

6. The method of claim 5 wherein said contingency requirement includes delaying submittal of the first trade order until all other non-contingent legs have been fully filled.

7. The method of claim 1 wherein said programmable electronic processing device is further operable to:
discretely submit a trade order to an exchange prior to when each leg becomes available; and
update the leg price for all remainder legs based on the fill price of the discretely submitted trade order and all other fully and partially filled trade orders.

8. The method of claim 1 wherein said programmable electronic processing device is further operable to dynamically adjust the leg price of at least one leg of the multi-leg instrument when current market activity reflects a change in market price of an instrument used for pricing a leg of the multi-leg instrument.

9. The method of claim 1 wherein:
the synthetic price for the multi-leg instrument is specified by a trader; and
the leg price for each leg instrument is determined by solving the multi-leg definition.

10. An apparatus for trading a multi-leg financial instrument, said apparatus comprising:
a graphical user display device;
a user input device;
a communication network for electronically communicating with one or more electronic exchanges; and
a programmable electronic processing device in communication with the display device, user input device, and communication network, the electronic processing device being programmed to take the following actions in response to input received from the user input device:
define a multi-leg instrument having two or more legs where each leg represents a financial instrument (leg instrument), a price (leg price) for the financial instrument, and a quantity (leg quantity) of the financial instrument that comprises one unit of the multi-leg instrument, said multi-leg instrument having a synthetic price represented by a multi-leg definition that equates the synthetic price for one unit of the multi-leg instrument to an aggregation of other items including the leg price and leg quantity of each leg;
determine a leg submittal trigger for each leg representing one or more requirements that must be met before the trade order for the leg can be submitted to an exchange;
monitor current market activity for each leg instrument to determine a current status for leg price availability and leg quantity availability;
submit a first trade order to an exchange at a leg price determined by the multi-leg definition and for the leg quantity for each leg in which the leg submittal trigger is met;
for each leg in which the leg quantity is not fully filled (remainder leg) after any quantity for any leg has been filled, calculate an updated leg price for such remainder leg based on the fill price(s) for all filled and partially filled legs;
send a subsequent trade order to an exchange for each remainder leg at the updated leg price and for the amount of the leg quantity that remains unfilled (remainder quantity) when the leg submittal trigger for the remainder leg is met;
and
repeating said calculate and send actions until all legs of the multi-leg instrument are fully filled.

11. The apparatus of claim 10 wherein the leg submittal trigger for one or more legs includes a wait requirement that delays submittal of:
the first trade order to an exchange until current market activity shows that each leg is available at the leg price and leg quantity; and
any subsequent trade order to an exchange until current market activity shows that each remainder leg is available at the leg price and remainder quantity.

12. The apparatus of claim 11 wherein:
each leg is available at the leg price and leg quantity when current market activity shows that the leg quantity of the respective trade order can be fully filled at a current market price that is equal to or more favorable than the leg price; and
each remainder leg is available at the updated leg price and at the remainder quantity when current market activity shows that the remainder leg quantity can be fully filled at a current market price that is equal to or more favorable than the updated leg price.

13. The apparatus of claim 10 wherein the leg submittal trigger for one or more legs includes a no wait requirement that immediately submits the first trade order to an exchange.

14. The apparatus of claim 10 wherein the leg submittal trigger for one or more legs includes a contingency requirement that delays submittal of the first trade order to an exchange until all contingency requirements have been met.

15. The apparatus of claim 14 wherein said contingency requirement includes delaying submittal of the first trade order until all other non-contingent legs have been fully filled.

16. The apparatus of claim 10 wherein said programmable electronic processing device is further operable to:
discretely submit a trade order to an exchange; and
update the leg price for all remainder legs based on the fill price of the discretely submitted trade order and all other fully and partially filled trade orders.

17. The apparatus of claim 10 wherein said programmable electronic processing device is further operable to dynamically adjust the leg price of at least one leg of the multi-leg instrument when current market activity reflects a change in market price of an instrument used for pricing a leg of the multi-leg instrument.

18. The apparatus of claim 10 wherein:
the synthetic price for the multi-leg instrument is specified by a trader; and
the leg price for each leg instrument is determined by solving the multi-leg definition.

19. A method for trading a multi-leg financial instrument, said method comprising:
defining a multi-leg instrument having two or more legs where each leg represents a financial instrument (leg instrument), a price (leg price) for the financial instrument, and a quantity (leg quantity) of the financial instrument that comprises one unit of the multi-leg instrument, said multi-leg instrument having a synthetic price represented by a multi-leg definition that equates the synthetic price for one unit of the multi-leg instrument to an aggregation of items including the leg price and leg quantity of each leg;
monitoring current market activity for each financial instrument of each leg to determine a current status for leg price availability and leg quantity availability;
submitting a first trade order to an exchange for each leg at the leg price and leg quantity when current market activity shows that each leg is available at the leg price and leg quantity;
for each leg in which the leg quantity is not fully filled (remainder leg) after any quantity for any leg has been filled, calculating an updated leg price for such remainder leg based on the fill price(s) for all filled and partially filled legs;
sending a subsequent trade order to an exchange for each remainder leg at the updated leg price and for the quantity of the leg that remains unfilled (remainder quantity) when current market activity shows that each remainder leg is available at the updated leg price and at the remainder quantity; and
repeating said calculating and sending steps until the multi-leg order is fully filled.

20. The method of claim 19, further comprising:
discretely submitting a trade order to an exchange prior to when each leg becomes available; and
updating the leg price for all remainder legs based on the fill price of the discretely submitted trade order and all other fully and partially filled trade orders.

21. The method of claim 19 wherein the financial instrument for at least one leg of the multi-leg instrument is a native instrument.

22. The method of claim 19 wherein the financial instrument for at least one leg of the multi-leg instrument is a synthetic instrument.

23. The method of claim 19 wherein at least one leg of the multi-leg instrument includes a dynamically adjustable leg price that changes when current market activity reflects a change in market price of an instrument used for pricing a leg of the multi-leg instrument.

24. The method of claim 19 wherein:
each leg is available at the leg price and leg quantity when current market activity shows that the leg quantity of the respective trade order can be fully filled at a current market price that is equal to or more favorable than the leg price; and
each remainder leg is available at the updated leg price and at the remainder quantity when current market activity shows that the remainder leg quantity can be fully filled at a current market price that is equal to or more favorable than the updated leg price.

25. The method of claim 19 wherein:
the synthetic price for the multi-leg instrument is specified by a trader; and
the leg price for each leg instrument is determined by solving the multi-leg definition.

26. An apparatus for allowing a trader to submit trade orders for a multi-leg financial instrument from an electronic processing device to one or more electronic exchanges, the apparatus comprising:
a graphical user display device;
a user input device;
a communication network for electronically communicating with one or more electronic exchanges; and
a programmable electronic processing device in communication with the display device, user input device, and communication network, the electronic processing device being programmed to take the following actions in response to input received from the user input device:
define a multi-leg instrument having two or more legs where each leg represents a financial instrument (leg instrument), a price (leg price) for the financial instrument, and a quantity (leg quantity) of the financial instrument that comprises one unit of the multi-leg instrument, said multi-leg instrument having a synthetic price represented by a multi-leg definition that equates the synthetic price for one unit of the multi-leg instrument to an aggregation of other items including the leg price and leg quantity of each leg;
monitor current market activity for each financial instrument of each leg to determine a current status for leg price availability and leg quantity availability;
submit a first trade order to an exchange for each leg at the leg price and leg quantity when current market activity shows that each leg is available at the leg price and leg quantity;
for each leg in which the leg quantity is not fully filled (remainder leg) after any quantity for any leg has been filled, calculate an updated leg price for such remainder leg based on the fill price for all filled and partially filled legs;
send a subsequent trade order to an exchange for each remainder leg at the updated leg price and for the quantity of the leg that remains unfilled (remainder quantity) when current market activity shows that each remainder leg is available at the updated leg price and at the remainder quantity; and
repeat said calculate and send actions until the multi-leg order is fully filled.

27. The apparatus of claim 26 wherein said programmable electronic processing device is further operable to:
discretely submit a trade order to an exchange prior to when each leg becomes available; and
update the leg price for all remainder legs based on the fill price of the discretely submitted trade order and all other fully and partially filled trade orders.

28. The apparatus of claim 26 wherein said programmable electronic processing device is further operable to dynamically adjust the leg price of at least one leg of the multi-leg instrument when current market activity reflects a change in market price of an instrument used for pricing a leg of the multi-leg instrument.

29. The apparatus of claim 26 wherein:
the synthetic price for the multi-leg instrument is specified by a trader; and
the leg price for each leg instrument is determined by solving the multi-leg definition.

30. The apparatus of claim 26 wherein:
each leg is available at the leg price and quantity when current market activity shows that the leg quantity of the respective trade order can be fully filled at a current market price that is equal to or more favorable than the leg price; and
each remainder leg is available at the updated leg price and at the remainder quantity when current market activity shows that the remainder leg quantity can be fully filled at a current market price that is equal to or more favorable than the updated leg price.
